(19) United States
(12) Patent Application Publication
(10) Pub. No.: US 2025/0041991 A1
(43) Pub. Date: Feb. 6, 2025

(54) COOLANT DEVICE FOR GRINDING

(71) Applicant: Shounan Engineering Inc., Kagoshima (JP)

(72) Inventors: Masaji SAZAWA, Kagoshima (JP); Naosuke SAZAWA, Kagoshima (JP)

(73) Assignee: Shounan Engineering Inc., Kagoshima (JP)

(21) Appl. No.: 18/716,918

(22) PCT Filed: Dec. 6, 2022
(86) PCT No.: PCT/JP2022/044914

§ 371 Date: Jun. 5, 2024

(30) Foreign Application Priority Data
Dec. 7, 2021 (JP) 2021-198743

(51) Int. Cl. B24B 55/02

(52) U.S. Cl. CPC B24B 55/02

(57) ABSTRACT

The chips in coolant having passed through a first bath 202A and a second bath 202B are attracted to a permanent magnets 307B of an endless chain 302B and discharged into a chip box 308. Magnetic force of a permanent magnets 307A of an endless chain 302A is set to be stronger than magnetic force of the permanent magnets 307B of the endless chain 302B. Consequently, fine chips in coolant passing through a third bath 202C and a fourth bath 202D can be attracted to the permanent magnets 307A of the endless chain 302A and discharged into the chip box 308. Further, when coolant having passed through the fourth bath 202D flows into a sub-coolant tank 105, a coolant pump 107 feeds the coolant within the sub-coolant tank 105 to a magnetic inline filter 10 so as to further filtering the coolant.

### TECHNICAL FIELD

The present invention relates to a coolant device for a machine tool. More particularly, the present invention relates to a coolant device for grinding used for separating sludge-like fine chips discharged when gears are ground.

### BACKGROUND ART

Oily or water-soluble coolant is used in a coolant device used for a machine tool for discharging chips from position of grinding, cooling works and tools or improving lubrication, etc. Similarly, oily or water-soluble coolant is used also as coolant for grinding machine of gears. A recirculation device of water-soluble coolant for a grinding machine is presented in which chips floating on water-soluble coolant is removed efficiently by blowing them together with an injection nozzle to separate them in a water-soluble coolant device used for a grinding machine of gears (Patent Document 1). The gear grinding machine of gears in Patent Document 1 is one in which grinding is conducted with a vitrified grinding wheel. On the other hand, it has been required in recent years for gear surfaces in a transmission of an automobile, etc., to have smooth surface and precise dimensions thereof. Further, grinding method with high productivity is also required.

For this, grinding wheels of CBN (cubic boron nitride) having high heat resistance and enabling high speed grinding are used as a grinding wheel of gear surfaces instead of vitrified wheels. Fine chips (sludge) due to high-speed grinding generally does not float when grinding of gears is conducted using a grinding wheel of CBN. However, it is necessary to separate further finer chips using paper filter, etc., after large magnetic chips have been separated from coolant by a magnetic drum. When paper filter is used, it becomes necessary to take care for periodical exchange thereof, and such paper filter must be dealt with as industrial wastes, resulting in of high expense. Along with it, generating wastes is not favorable in view of circumference. Further, the coolant device in Patent Document 1 uses a magnetic drum and a cyclone type filtering device. Such cyclone type filtering device has an advantage without generating industrial wastes.

Furthermore, a processing equipment of grinding fluid is presented such that so called sludge, in which metal chips, abrasive grains of grinding wheels, etc., coexist, contained in coolant used in a roll grinding machine, etc., is separated (Patent Document 2). With the processing equipment of grinding fluid of Patent Document 2, a tank is divided into two baths, and dirty coolant returning from a machine tool flows into one bath, while purified coolant flows into the other bath. Moreover, with the processing equipment of grinding fluid of Patent Document 2, a magnet or magnets is/are disposed on the lower side surface (outside surface) of the bottom plate of a vessel for grinding fluid and sludge is discharged from the upper side surface (inside surface) of the bottom plate with scraping members driven by chains, in order to separate magnetic chips. On the other hand, the present applicant presented a magnetic inline filter having a filter composed of magnetic chips themselves (Patent Document 3). As this magnetic inline filter has a filter composed of magnetic chips themselves, and has an advantage such that it is not necessary to use filters as of consumables or wastes. Further, there is no need for backwash, etc., and it may be good only to cause stored magnetic chips to flow off by coolant, thus discharging them.

### PRIOR ART DOCUMENTS

### Patent Documents

Patent Document 1: JP, Published Patent Application No. 2019-181612
Patent Document 2: JP, Examined Patent Application Publication No. S63-59824
Patent Document 3. WO2014/098040

### SUMMARY OF THE INVENTION

### Problems to be Solved by the Invention

In a case of grinding gears using a grinding wheel of CBN, oily coolant is used in general. When oily coolant is used, fine oily chips are coated grain by grain with oil. Consequently, recovery rate of chips becomes low with the magnetic separator using a magnetic drum as disclosed in Patent Document 1. The reason for this is considered to be because chips have weak magnetizing force as they are coated with oil so that they flow off from the magnetic separator with velocity of flowing coolant. Further, while a cyclone type filtering device has an advantage without generating industrial wastes, it requires a peculiar pump for it, thus bringing loss of energy. Furthermore, separating performance of fine chips coated with oil of a cyclone type filtering device is not high. With the processing equipment of grinding fluid of Patent Document 2, sludge is discharged with scraping members for separating magnetic chips, which may bring situation such that the scraping members wear away and chips mingle into coolant, thus it becomes necessary to exchange the scraping members having worn away periodically.

The present invention, under the background explained above, attains the following objects.

It is an object of the present invention to present a coolant device for grinding that can efficiently separate fine chips from coolant.

It is another object of the present invention to present a coolant device for grinding that does not generate industrial wastes.

It is still another object of the present invention to present a coolant device for grinding without bringing much loss of energy.

### Means for Solving the Problems

The present invention employs the following means for solving the above explained problems.

That is, a coolant device for grinding according to the present invention 1 is a coolant device for grinding for separating chips from coolant discharged from a grinding machine, the coolant device for grinding comprising:
a coolant tank made of non-magnetic material receiving the coolant discharged from the grinding machine and separating chips.
a magnetic chip conveyer disposed on underside of a bottom plate of the coolant tank, provided with permanent magnets disposed so as to have determined distance between each other and also provided with an endless chain driven rotationally, thus adsorbing magnetic chips precipitated on the bottom plate of the coolant tank with magnetic force of the permanent magnets and separating the magnetic chips from the coolant to discharge them,
a magnetic inline filter for purifying coolant fed from the coolant tank and feeding the purified coolant to the grinding machine, said magnetic inline filter being provided with: a pipe-shaped body as a double pipe consisting of an inner pipe and an outer pipe, which are coaxially disposed, for causing the coolant purified in the coolant tank to flow through space as a gap between the inner pipe and the outer pipe of the double pipe; inner circumferential side magnets disposed on the inner circumferential side of the inner pipe; and outer circumferential side magnets disposed on the outer circumferential side of the outer pipe, and
a pump for feeding the coolant, from which magnetic chips have been separated in the coolant tank, to the magnetic inline filter.

The coolant device for grinding according to the present invention 2 is, in the present invention 1,
the coolant tank is composed of plurality of baths contoured with partition walls respectively so that the coolant flows in a direction, and magnetic force of permanent magnets disposed underside of the bottom plate of downstream side bath is stronger than that of permanent magnets disposed underside of the bottom plate of upstream side bath of flow of the coolant.

The coolant device for grinding according to the present invention 3 is, in the present invention 2,
the plurality of baths are composed of a first bath, a second bath, a third bath and a fourth bath sequentially in a direction of flow of the coolant, and magnetic strength of the permanent magnets is arranged such that the first bath and the second bath are of a same magnetic strength and the third bath and the fourth bath are of another same magnetic strength stronger than that of the first bath and the second bath.

The coolant device for grinding according to present invention 4 is, in selected one of the present invention 1 to 3,
the coolant is oily one and the grinding machine is a gear grinding machine grinding gear face with a grinding wheel of CBN.

### Effect of the Invention

The coolant device for grinding according to the present invention separates chips in coolant with a magnetic chip conveyer and a magnetic inline filter, so that fine chips can be efficiently separated from coolant.

### BRIEF EXPLANATION OF THE INVENTION

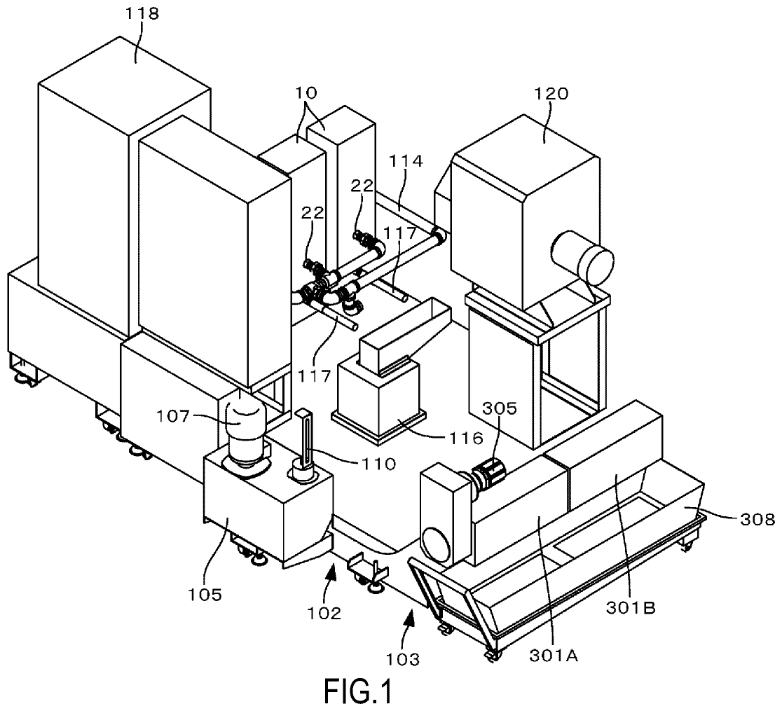

FIG. 1 is a whole perspective view showing the coolant device for grinding according to the present invention.

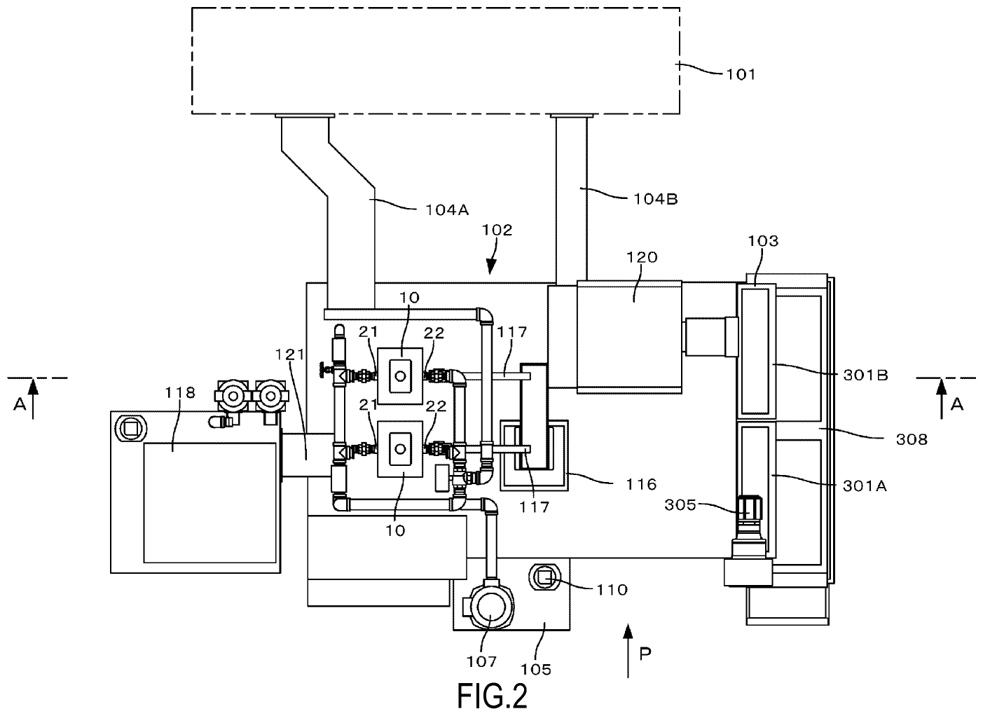

FIG. 2 is a planar view of FIG. 1.

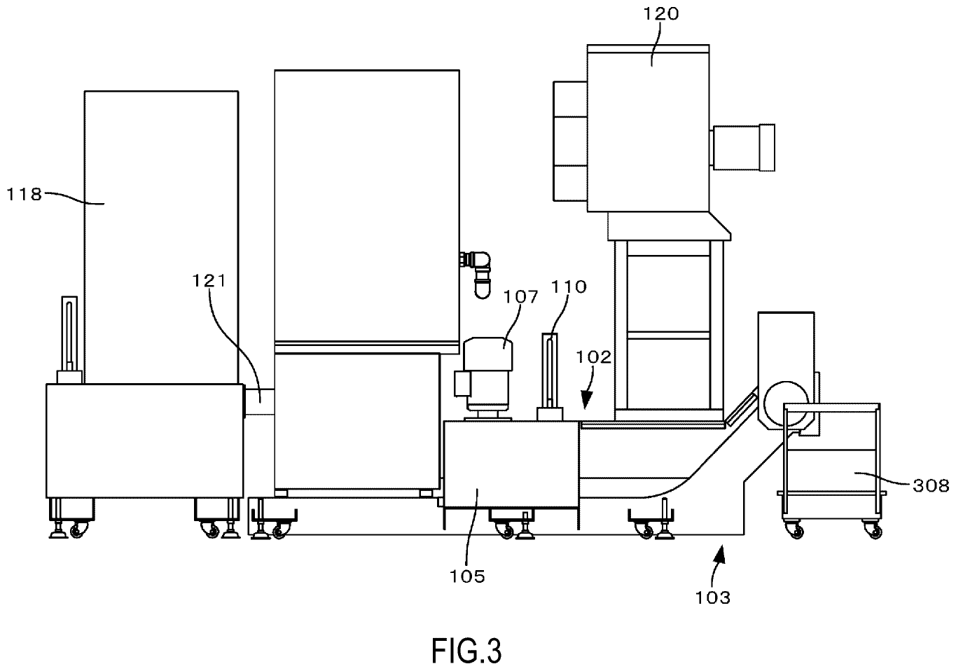

FIG. 3 is a view as seen in a direction of an arrow P in FIG. 2.

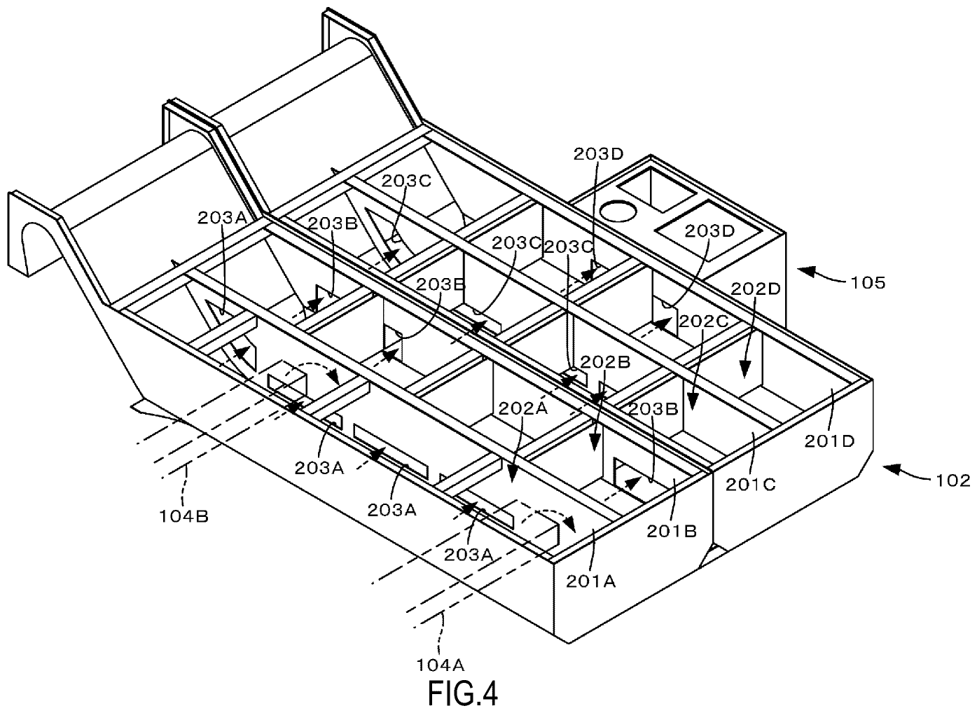

FIG. 4 is a perspective view of a coolant tank in FIG. 1 showing a situation where the upper side lid is taken off.

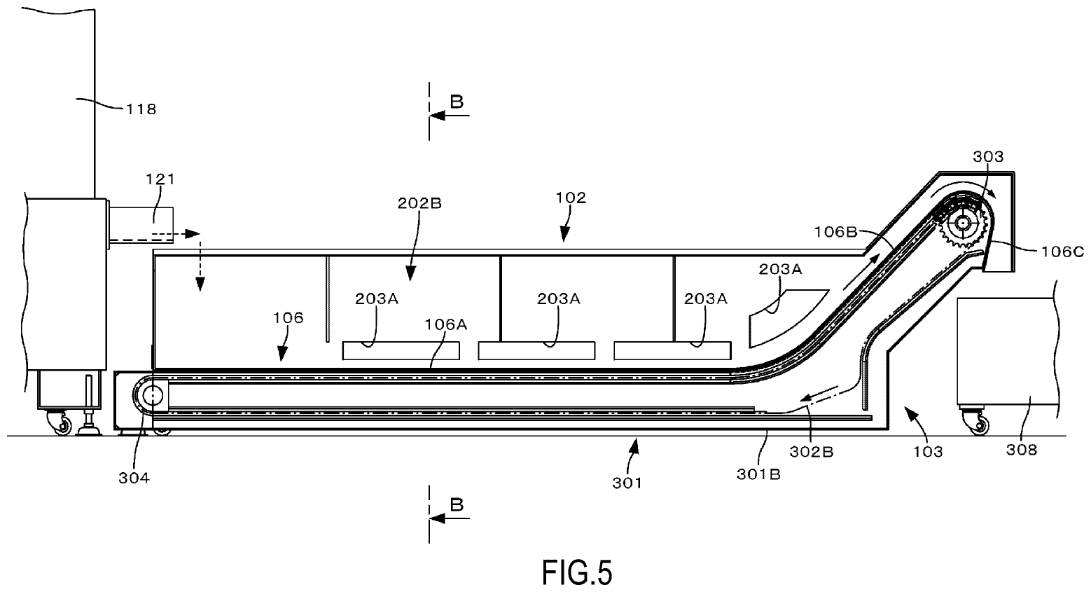

FIG. 5 is a sectional view of FIG. 2 taken in a plane A-A shown with machine elements placed on the upper side of the coolant tank omitted.

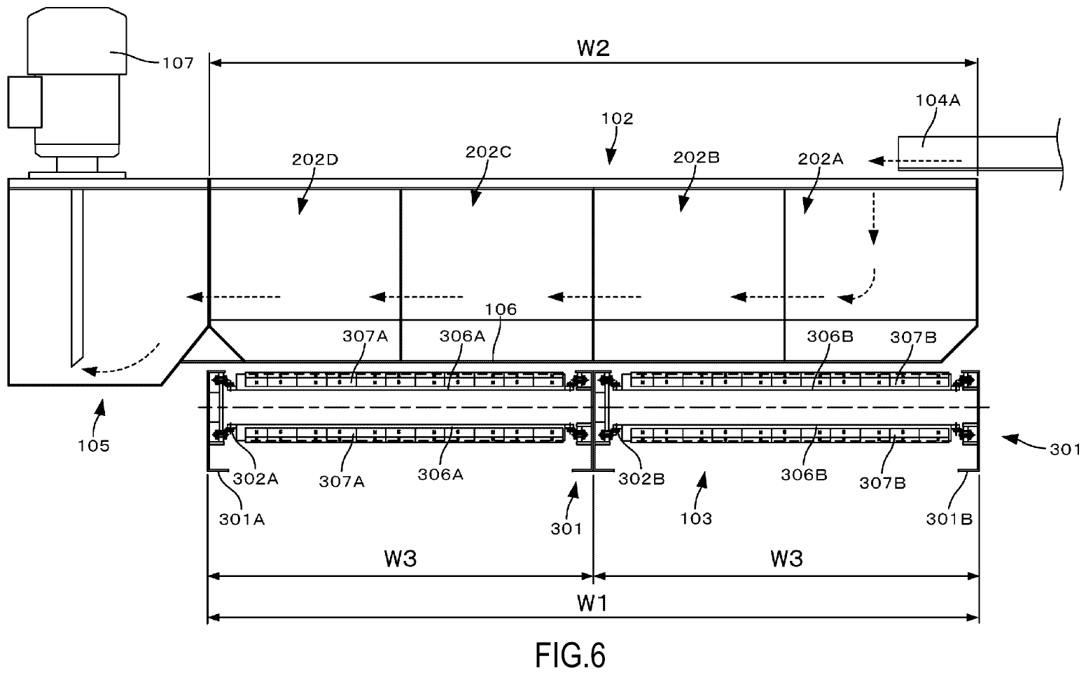

FIG. 6 is a sectional view of FIG. 5 taken in a plane B-B.

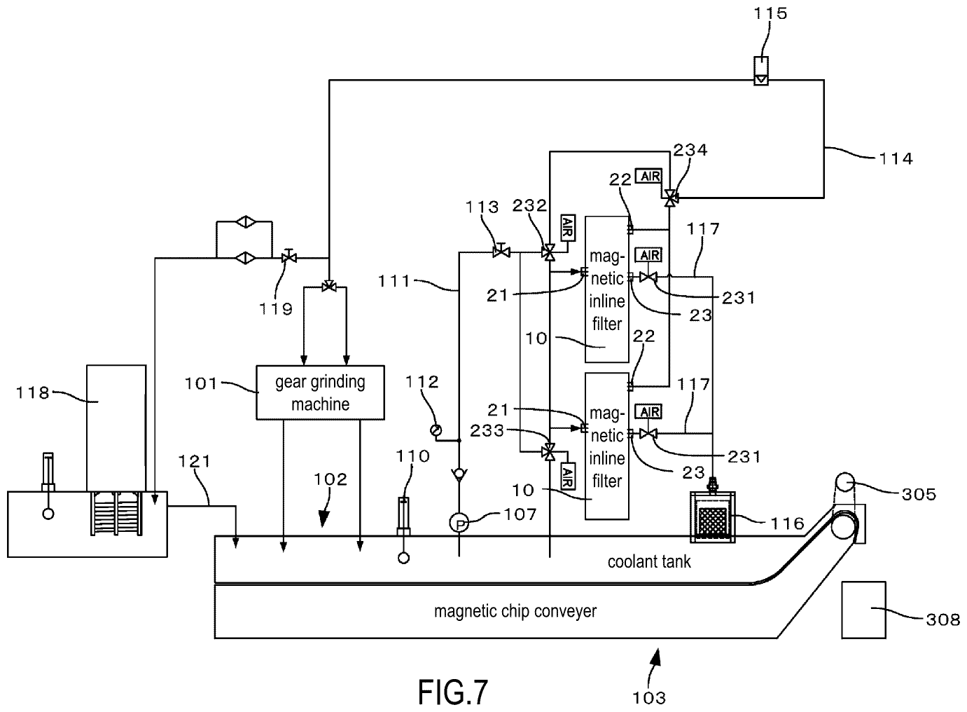

FIG. 7 is schematic view showing a circuit of coolant in the coolant device according to the present invention.

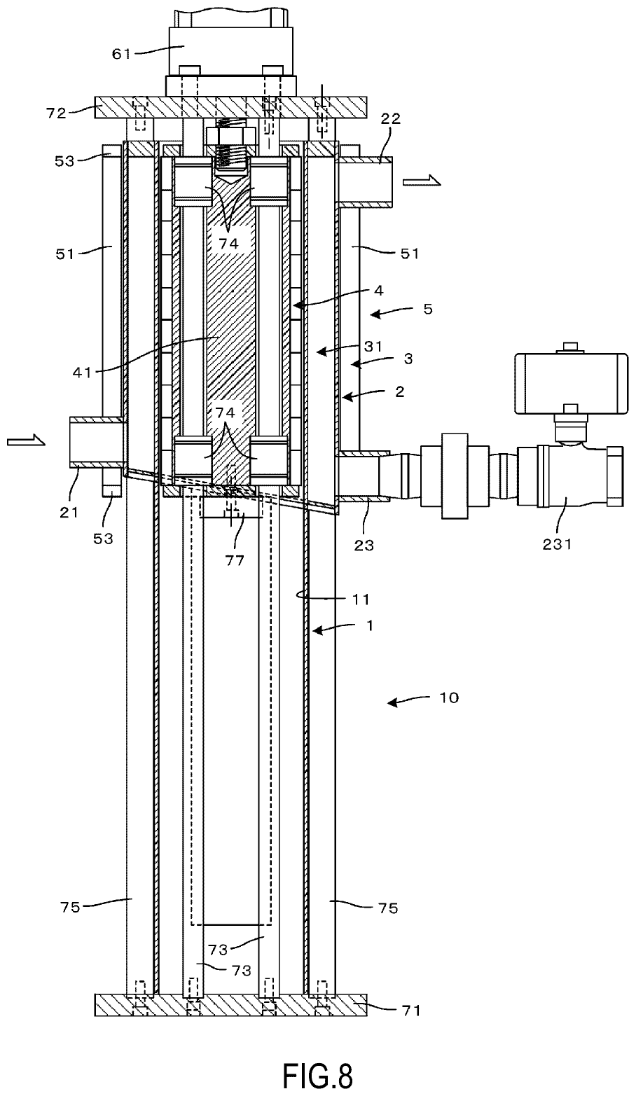

FIG. 8 is a longitudinally sectional view of a magnetic inline filter shown in FIGS. 1 and 2, showing a situation where coolant is fed through a feeding port to a section of working with a piston rod of a fluid cylinder retracted to the uppermost position.

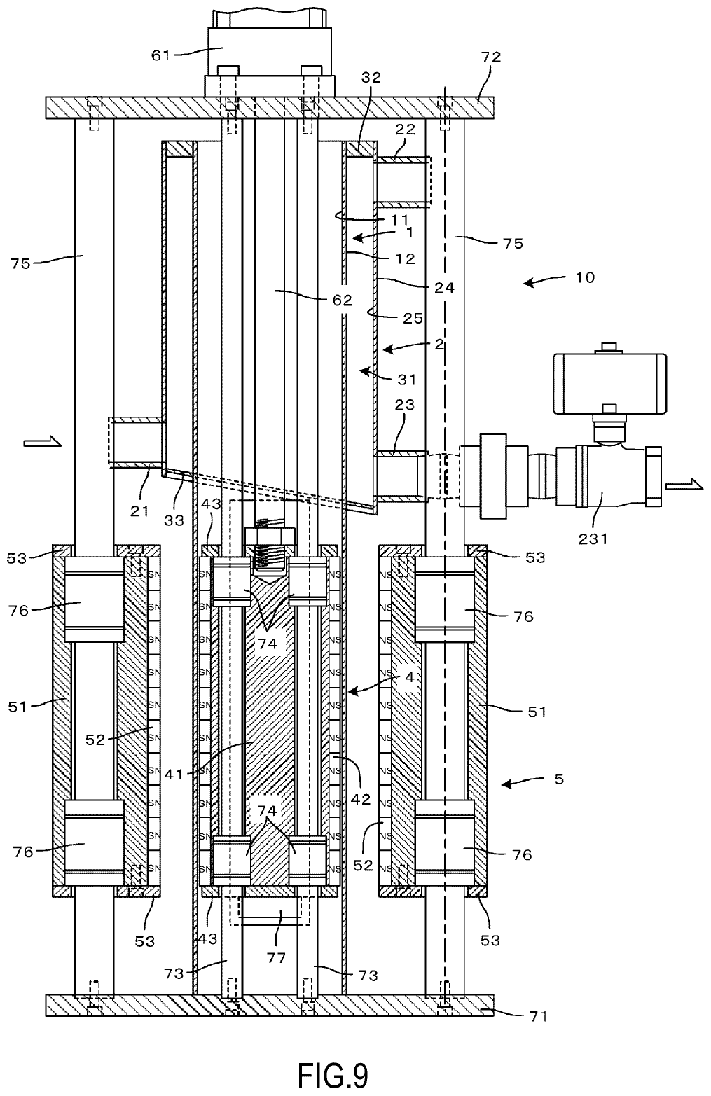

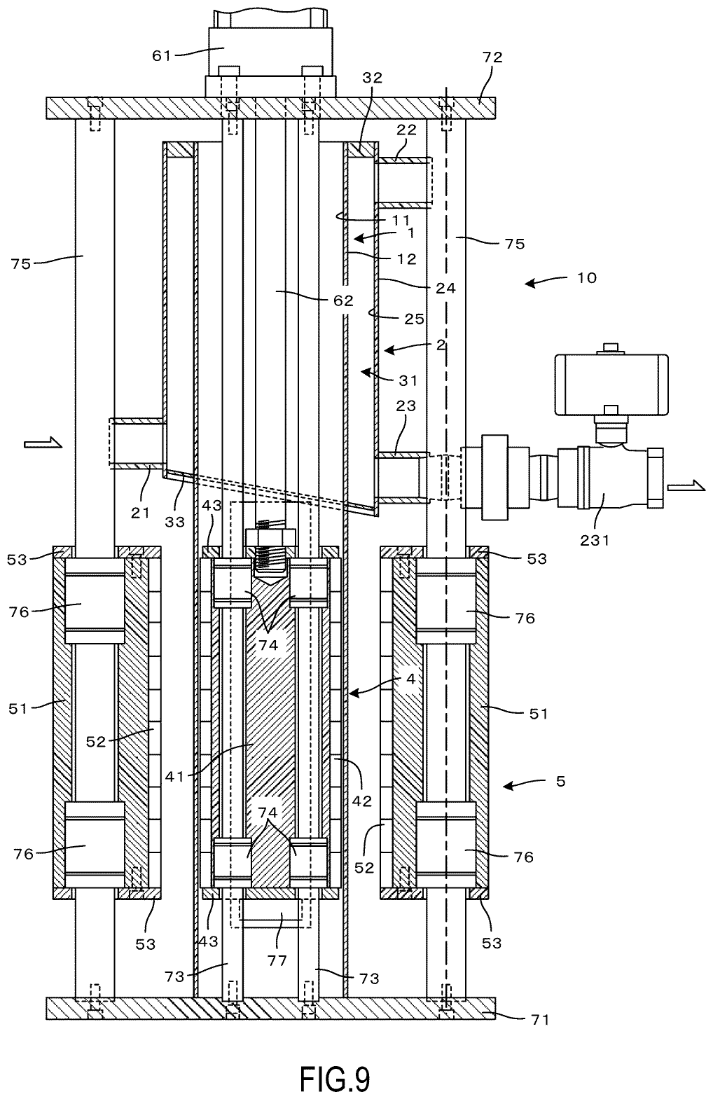

FIG. 9 is a view showing a situation where coolant is discharged through a discharging port disposed in a lower position, discharging chips stored therein outwards, with the piston rod shown in FIG. 8 extended to the lowermost position.

### DETAILED EXPLANATION OF THE EMBODIMENTS

### (Summary of the Coolant Device for Grinding)

Embodiments of the present invention will be explained referring drawings below. FIG. 1 is a whole perspective view showing the coolant device for grinding according to the present invention, FIG. 2 is a planar view of FIG. 1, and FIG. 3 is a view as seen in a direction of an arrow P in FIG. 2. FIG. 4 is a perspective view of a coolant tank in FIG. 1 showing a situation where the upper side lid is taken off, and FIG. 5 is a sectional view of FIG. 2 taken in a plane A-A shown with machine elements placed on the upper side of the coolant tank omitted. FIG. 6 is a sectional view of FIG. 5 taken in a plane B-B, and FIG. 7 is schematic view showing a circuit of coolant in the coolant device according to the present invention. FIG. 8 is a longitudinally sectional view of a magnetic inline filter, showing a situation where coolant is fed through a feeding port to a working section with a piston rod of a fluid cylinder retracted to the uppermost position. Further,

FIG. 9 is a view showing a situation where coolant is discharged through a discharging port disposed in a lower position, discharging chips stored therein outwards, with the piston rod shown in FIG. 8 extended to the lowermost position. As shown in FIGS. 1 to 9, larger chips of chips from gears having been ground with a grinding wheel of CBN of a gear grinding machine 101 (FIG. 2) and chips washed off from jigs are collected by chip conveyer (not shown) of the gear grinding machine 101. After this, the chips are collected along with oily coolant through coolant collecting channels 104A and 104B into a coolant tank 102.

### (Structure of a Coolant Tank)

A coolant tank 102 is made of stainless steel (non-magnetic material) and, as seen in FIG. 5, its right-side end portion is formed to have an inclined face rising diagonally up to the right. Magnets are disposed on a magnetic chip conveyer 103 in a lower side portion of a bottom plate 106 of the coolant tank 102 and these magnets move along the underside surface of the bottom plate 106 in close proximity thereof and the magnets adsorb magnetic chips precipitating onto the bottom plate 106 of the coolant tank 102 and separate them from coolant to discharge. A sub-coolant tank 105 is formed integrally with the coolant tank 102 on the side face thereof (under side in FIG. 2). A coolant pump 107 and a fluid level gauge 110 are placed on the upper face of the sub-coolant tank 105. The fluid level gauge 110 detects an upper limit and a lower limit of coolant surface in the sub-coolant tank 105 and displays alarm on a screen of an operator panel (not shown) of the gear grinding machine 101.

Two magnetic inline filters 10 are disposed on the upper face of the coolant tank 102. These magnetic inline filters 10 are ones presented by the present applicant and structure and function thereof are known (Patent Document 3). The coolant pump 107 feeds coolant within the sub-coolant tank 105 to an inlet port 21 of the magnetic inline filter 10 (see FIGS. 7 to 9). As seen in FIG. 7, a pressure meter 112 and a manual change-over valve 113 are provided at a midway position of a pipeline 111 connecting the coolant pump 107 and the inlet port 21. As chips in coolant fed into the inlet port 21 are adsorbed under the magnetic field in the magnetic inline filter 10, coolant is filtered.

Filtered coolant is fed through feeding port (discharging port of coolant) 22 of the magnetic inline filter 10 and a coolant feeding pipe 114 (see FIG. 7) to a working section (contact position of a grinding wheel of CBN with a gear) of gear grinding machine, so that grinding operation can be conducted with clean coolant. A flow switch 115 for detecting flow rate of coolant flowing through the coolant feeding pipe 114 is provided in the midway of the coolant feeding pipe 114 (see FIG. 7) and, detecting lower limit of flow rate, alarm is displayed on a screen in an operator panel (not shown) of the gear grinding machine 101.

A mesh basket 116 is disposed on the upper face of the coolant tank 102. A coolant discharging pipe 117 for discharging coolant discharged through a discharging port 23 of the magnetic inline filter 10 (see FIGS. 7 to 9) into the mesh basket 116 is connected to the discharging port 23. The mesh basket 116 separates chips from coolant and stores the chips therein and, along with this, returns coolant, from which chips have been separated, back to the coolant tank 102. Chips stored in the mesh basket 116 are cleaned off periodically removing the mesh basket 116 from the coolant tank 102.

As shown in FIG. 4, the coolant tank 102 is composed of four fluid baths (first bath 202A, second bath 202B, third bath 202C and fourth bath 202D) contoured with partition walls 201A, 201B and 201C, respectively in the longitudinal direction. Further, weirs are disposed in the first bath 202A, second bath 202B, third bath 202C and fourth bath 202D in a crossing direction, respectively. Each of these weirs is formed to be shorter than the depth of each bath. That is, a gap for chips to pass through is formed in the lower portion of each of weirs. The weirs are ones for preventing turbulent flow of coolant and causing sludge-like chips not to be diffused. Coolant discharged from the gear grinding machine 101 flows through the collecting channels 104A, 104B into the first bath 202A of the coolant tank 102. Plurality of openings 203A, 203B and 203C are formed in the lower portions of respective partitions 201A, 201B and 201C, respectively. Also, two openings 203D are formed in the partition 201D between the coolant tank 102 and the sub-coolant tank 105. Consequently, when coolant within the sub-coolant tank 105 is pumped up with the coolant pump 107, coolant within the first bath 202A flows through the second bath 202B, the third bath 202C and the fourth bath sequentially, thus flowing into the sub-coolant tank 105. Here, with the coolant device for grinding of this embodiment, only one coolant pump 107 is used to conduct from feeding into the grinding machine up to filtering, resulting in energy conservation.

### (Structure of Magnetic Chip Conveyer)

As shown in FIG. 5, the bottom plate 106 of the coolant tank 102 consists of a flat portion 106A, an inclined portion 106B and a chip falling portion 106C. Magnetic chip conveyer 103 is provided with a chip conveyer body 301 in a form of box elongated in left-right direction in FIG. 5, the chip conveyer body 301 being disposed under the flat portion 106A, the inclined portion 106B and the chip falling portion 106C of the bottom plate 106 of the coolant tank 102. As shown in FIG. 6, width W1 of the chip conveyer body 301 is substantially same as width W2 of the first bath 202A to the fourth bath 202D of the coolant tank 102. The chip conveyer body 301 is formed so as to integrate two chip conveyer bodies 301A, 301B, each having a width W3 equal to ½ of the width W1. Endless chains 302A, 302B are disposed so as to envelope sprocket wheels 303, 304 in the chip conveyer bodies 301A and 301B respectively. Though not shown, the sprocket wheels 303, 304 are provided to be rotatable around an axis respectively in the chip conveyer bodies 301A, 301B, respectively. The sprocket wheel 303 in the chip conveyer body 301A and the sprocket wheel 303 in the chip conveyer body 301B are connected with a rotatable shaft (not shown) disposed in a direction perpendicular to the plane of FIG. 5. Similarly, also the sprocket wheel 304 in the chip conveyer body 301A and the sprocket wheel 304 in the chip conveyer body 301B are connected with a rotatable shaft (not shown) disposed in a direction perpendicular to the plane of FIG. 5. On the side of the chip conveyer body 301A, the sprocket wheel 303 at the right end of FIG. 5 is rotated in clockwise direction with a motor 305 and the endless chains 302A, 302B moves in clockwise direction in FIG. 5.

Plurality of plate-shaped magnet holding members 306A, 306B are fixed to the endless chains 302A, 302B to be equidistantly apart from each other in the longitudinal direction thereof, respectively. Permanent magnets (of a rare earth material, etc.) 307A are fixed by adhesion to the magnet holding members 306A on the endless chain 302A. Similarly, permanent magnets (of a rare earth material, etc.) 307B are fixed by adhesion to the magnet holding members 306B on the endless chain 302B. Plurality of the permanent magnets 307A, 307B are fixed to be side by side in left-right direction in FIG. 6 respectively. Thickness of the permanent magnets 307A is formed to be thicker than thickness of the permanent magnets 307B, so that magnetic force (magnetic flux density) of the permanent magnets 307A is set to be stronger than magnetic force of the permanent magnets 307B. That is, such magnets can adsorb also fine sludge-like chips.

### (Action of Magnetic Chip Conveyer)

When the sprocket wheels 303 are rotated in clockwise direction in FIG. 5 with the motor 305, the endless chains 302A, 302B moves along the underside face of the bottom plate 106 of the coolant tank 102 in clockwise direction in FIG. 5. Consequently, chips having deposited on the bottom plate 106 move rightwards in FIG. 5 attracted by the permanent magnets 307A, 303B. That is, chips separated from coolant moves through the flat portion 106A and the inclined portion 106B to the chip falling portion 106C. Chips fall by gravity at the inclined portion 106B. The endless chains 302A, 302B are reversed at the sprocket wheels 303 at right end and the permanent magnets 307A, 307B leave from the chip falling portion 106C, so that chips fall from the chip falling portion 106C into a chip box 308

Chips in coolant having passed through the first bath 202A and the second bath 202B, attracted by the permanent magnets 307B of the endless chain 302B, are discharged into the chip box 308. However, chips of a tiny amount remain in coolant having flowed into the third bath 202C. Magnetic force of the permanent magnets 307A of the endless chain 302A is set to be stronger than that of the permanent magnets 307B of the endless chain 302B. Consequently, it is possible to discharge chips of a tiny amount in coolant passing through the third bath 202C, the fourth bath 202 D into the chip box 308, attracting them with the permanent magnets 307A of the endless chain 302A. However, as chips of a tiny amount in coolant are not deposited, they cannot be dealt with the magnetic chip conveyer 103. Consequently, when coolant having passed through the fourth bath 202D flows into the sub-coolant tank 105, the coolant pump 107 feeds coolant within the sub-coolant tank 105 to the magnetic inline filter 10 and further filtering is conducted.

### (Structure of Magnetic Inline Filter)

As shown in FIG. 8, FIG. 9, the magnetic inline filter 10 has a pipe-shaped body 3 composed of an inner pipe 1 and outer pipe 2, both of which are made of a non-magnetic material such as austenitic stainless steel, etc. The pipe-shaped body 3 is composed of an inner circumferential side magnet 4 disposed on the inner circumferential face of the inner pipe 1, an outer circumferential side magnet 5 disposed on the outer circumferential face of the outer pipe 2 and a fluid cylinder 61 causing the inner circumferential side magnet 4 and the outer circumferential side magnet 5 to move in axial direction.

The pipe-shaped body 3 is a duplex pipe in which the inner pipe 1 and the outer pipe 2 are disposed in a coaxial manner. The axial length of the inner pipe 1 is formed to be nearly twice of the axial length of the outer pipe 2, and the inner pipe 1 is placed on the rectangular bottom plate 71 perpendicularly thereto with the lower end of the inner pipe 1 fixed by welding to the bottom plate 71. The outer pipe 2 is disposed on the upper side of the inner pipe 1 and coolant flows through a space 31 as a gap between the inner pipe 1 and the outer pipe 2. An upper lid 32 is welded to the pipe-shaped body 3 at upper end of the space 31 and the bottom lid 33 is welded to the pipe-shaped body 3 at the lower end of the space 31, thus the inner pipe and the outer pipe 2 are integrated with the space 31 contoured.

An inlet port 21 for introducing coolant (sewage containing chips) into the space 31 is formed in the outer pipe 2 near to the lower end of axial length thereof. Also, a feeding port 22 for feeding coolant having been purified in the space 31 to working section is formed in the outer pipe 2 near to the upper end of axial length thereof. Furthermore, a discharging port 23 is formed in the outer pipe 2 at a position lower than the inlet port 21, the discharging port 23 being one for discharging chips stored in the space 31 outwards from the space 31. A change-over valve 231 operated with a solenoid is provided at the discharging port 23, by which chips are discharged into the mesh basket 116 on the coolant tank 102. When coolant is filtered, the change-over valve 231 shuts the discharging port 23. The bottom lid 33 is formed on an inclined face descending from the inlet port 21 towards the discharging port 23, so that chips is discharged outwards easily through the discharging port 23.

The inner circumferential side magnet 4 is disposed on the inner circumferential face 11 of the inner pipe 1 to keep somewhat gap between it and the inner circumferential face 11. The inner circumferential side magnet 4 is formed of plurality of magnets 42 fixed to each other with adhesive, etc. The magnets 42 are formed to have sector shape in a plane perpendicular to axis thereof, plurality (twelve) of them are disposed with an equal angular distance (30 degrees) between every neighboring two of them along the whole periphery of the inner circumferential face 11 of the inner pipe 1 and fixed to a cylindrical magnet holding body 41. Ten magnets 42 are piled up in axial direction along substantially same axial length as that of the outer pipe 2.

The inner circumferential side magnet 4 is movable in axial direction of the inner pipe 1 and driven between a position of filtering confronting the space 31 and another position of chip discharging away from the space 31. That is, three column-shaped guide rods 73 made of steel for structure are fixed perpendicularly between the rectangular lower plate 71 and a rectangular upper plate 72. The upper plate 72 is disposed on the upper side of the pipe-shaped body 3 with somewhat distance therefrom. The guide rods 73, held slidably by cylindrical linear bushes 74, 74 respectively, extend perpendicularly through the magnet holding body 41. The linear bushes 74, 74 are fixed with holding plates 43, 43 at the upper end and at the lower end of the magnet holding body 41 respectively. The holding plates 43, 43, being of disc shape, are fixed on the upper end face of the magnet 42 and on the lower end face of the magnet 42 respectively. Plurality of balls (not shown) are interjacent rotatably between the guide rods 73 and the linear bushes 74, 74 respectively so as to enable smooth and nimble linear motion.

A fluid cylinder 61 is fixed to the upper side face of the upper plate 72 and a piston rod 62 protruding from the lower end of the fluid cylinder 61 is screwed into the upper end face of the magnet holding body 41 to be fixed there. Consequently, the inner circumferential side magnet 4 is driven between a position of filtering confronting the space 31 and another position of chip discharging away from the space 31 by changing fluid pressure supplied to the fluid cylinder 61. The outer circumferential side magnet 5 is disposed on the outer circumferential face 24 of the outer pipe 2 so as to keep somewhat gap between it and the outer circumferential face 24. The outer circumferential side magnet 5 is composed of two semi-circular magnet holding bodies 51. 51 and plurality of magnets 52 fixed with adhesive to the inner circumferential face of the magnet holding bodies 51, 51 respectively. The magnet holding bodies 51, 51, made of magnetic metal such as steel for structure, etc., are formed to have substantially same axial length as the axial length of the outer pipe 2. The magnets 52 are formed to have sector shape in section in plane perpendicular to axial direction, plurality of them are disposed with an equal angular distance between every neighboring two of them along the whole periphery of the outer circumferential face 24 of the outer pipe 2 and ten of them are piled up in axial direction to be disposed along substantially same axial length as that of the outer pipe 2.

The outer circumferential side magnet 5 is movable in axial direction of the outer pipe 2 and is driven between a position of filtering confronting the space 31 and another position of chips discharging away from the space 31. That is, four column-shaped guide rods 75 are fixed perpendicularly between the rectangular lower plate 71 and the rectangular upper plate 72. Two of the guide rods 75 extend perpendicularly through the magnet holding bodies 51, 51 and are held slidably by cylindrical linear bushes 76, 76 respectively. The linear bushes 76, 76 are fixed at the upper end and at the lower end of the magnet holding bodies 51, 51 with holding plates 53, 53, respectively. The holding plates 53, 53, being plates of semi-circular shape in a plane perpendicular to axial direction thereof, are fixed to the upper end face and the lower end face of the magnetic holding body 51, 51, respectively.

Plurality of balls (not shown) are interjacent rotatably between the guide rods 75 and the linear bushes 76, 76 respectively so as to enable smooth and nimble linear motion.

The outer circumferential side magnet 5 is driven synchronously with the inner circumferential side magnet 4. The holding plate 53 at the lower end of the outer circumferential side magnet 5 and the holding plate 43 at the lower end of the inner circumferential side magnet 4 are connected by a connecting plate 77 having a rectangular section in a plane perpendicular to axial direction. Consequently, the inner circumferential side magnet 4 and the outer circumferential side magnet 5 are driven between a position of filtering confronting the space 31 and another position of chip discharging away from the space 31 synchronously by changing fluid pressure supplied to the fluid cylinder 61.

The magnets 42 of the inner circumferential side magnet 4 are fixed to the magnet holding body 41 made of magnetic material. Due to this, magnetic field lines start from N pole, pass through air and arrive at S pole. In this, as it is the inner pipe 1 made of non-magnetic material that is nearest to the magnets 42, the magnetic field lines are not bent at all. When chips flow into this magnetic field, they become captured on the outer circumferential face 12 of the inner pipe 1. Similarly, the magnets 52 of the outer circumferential side magnet 5 are fixed to the magnet holding body 51 made of magnetic material. Due to this, magnetic field lines start from N pole, pass through air and arrive at S pole. In this, as it is the outer pipe 2 made of non-magnetic material that is nearest to the magnets 52, the magnetic field lines are not bent at all. When chips flow into this magnetic field, they become captured on the inner circumferential face 25 of the outer pipe 2.

On the other hand, the inner circumferential side magnet 4 and the outer circumferential side magnet 5 are disposed so as to confront each other with different polarities. The magnets 42 of the inner circumferential side magnet 4 are set to have S-pole on the outer circumferential face side and N-pole on the inner circumferential face side. Further, the magnets 52 of the outer circumferential side magnet 5 are set to have N-pole on the inner circumferential face side and S-pole on the outer circumferential face side. It is known commonly that, when N-pole of one magnet is brought near to S-pole of another magnet, attraction force is generated. That is, for magnetic field lines exit from N-pole with positive magnetic quantity and arrive at S-pole with negative magnetic quantity. Consequently, magnetic field lines extending from N-pole with positive magnetic quantity to S-pole with negative magnetic quantity is formed between the magnets 52 of the outer circumferential side magnet 5 and the magnets 42 of the inner circumferential side magnet 4. Magnetic field in radial direction becomes strong in such a manner, so that chips in coolant are adsorbed to faces on both sides of the space 31 (an outer circumferential face 12 of the inner pipe 1 and an inner circumferential face 25 of the outer pipe 2) and such adsorbed chips are stored to be bridged. As a result, precise filtering becomes possible by causing coolant to pass through gaps between bridged chips. Further, chips are efficiently adsorbed under strong magnetic field in radial direction, so that special filter member becomes unnecessary. In short, chips themselves become filter.

### (Operation of Magnetic Inline Filter)

As shown in FIG. 8, the piston rod 62 of the fluid cylinder 61 is retracted up to the uppermost position as a position of filtering, in which the inner circumferential side magnet 4 and the outer circumferential side magnet 5 confront the space 31. In this state, the discharging port 23 is closed by actuating solenoid of the change-over valve 231. Coolant is brought through the inlet port 21 near to the lower end of the outer pipe 2 into the space 31 and fed through the feeding port 22 near to the upper end to the gear grinding machine 101. As magnetic field is strong in radial direction, chips in coolant are adsorbed on the wall faces on both sides of the space 31, so that coolant is filtered. When feeding of coolant continues, chips adsorbed on the wall faces are stored to be bridged. As a result, coolant passes through gaps between bridged chips, so that precise filtering becomes possible.

When working with the gear grinding machine has been finished, the piston rod 62 of the fluid cylinder 61 is extended to the lowermost position, as shown in FIG. 9, so that the inner circumferential side magnet 4 and the outer circumferential side magnet 5 are brought to the position of discharging chips away from the space 31. Consequently, magnetic force acting on the space 31 disappears, so that it becomes easy for chips adsorbed on the wall faces on both sides of the space 31 to leave therefrom. When the solenoid of the change-over valve 231 is actuated, chips is discharged through the discharging port 23 into the mesh basket 116 on the coolant tank 102. That is, coolant is brought through the inlet port 21 near to the lower end of the outer pipe 2 into the space 31 and coolant is discharged through the discharging port 23 disposed in the position lower than the inlet port 21. As the bottom lid 33 is formed on the inclined face lowering from the inlet port 21 towards the discharging port 23, chips stored in the space 31 can be easily discharged outwards through the discharging port 23. When chips are discharged, coolant can be fed to the gear grinding machine 101 without passing through the magnetic inline filter 10, by changing change-over valves 232, 233, 234.

### (Cooler, Mist Collector)

As shown in FIGS. 1 to 3, a cooler 118 for cooling coolant to a determined temperature is provided on the left side of the coolant tank 102. Coolant is fed to the cooler 118 to be cooled by operating a manual change-over valve 119 shown in FIG. 7. Coolant having been cooled is returned through a coolant collecting channel 121 to the coolant tank 102. A mist collector 120 provided on the coolant tank 102 as shown in FIGS. 1 to 3 collects mist that fills area of working, thus keeping environment of operation to be favorable, decreasing danger of fire and purifying environment.

With the coolant device for grinding according to the embodiment of the present invention, chips in coolant are separated with a magnetic chip conveyer and a magnetic inline filter, so that fine chips can be efficiently separated from coolant. Also, a coolant tank of the coolant device for grinding according to the embodiment of the present invention is composed of plurality of fluid baths separated with partition walls so as to cause coolant to flow in one direction and also composed such that magnetic force of permanent magnets disposed underside of the bottom plate of downstream side bath are stronger than that of permanent magnets disposed underside of the bottom plate of upstream side bath. Consequently, chips are at first attracted with the permanent magnets 307B on the endless chain 302B disposed underside of the bottom plate of the upstream side bath and then discharged into the chip box 308. In the next, fine chips in coolant that could not be discharged in upstream side can be attracted with the permanent magnets 307A on the endless chain 302A disposed underside of the bottom plate of the downstream side bath and then discharged into the chip box 308. Further, the coolant device for grinding according to the embodiment of the present invention does not use consumables such as paper filter. Due to this, industrial wastes or running costs are reduced. Moreover, as the coolant device for grinding according to the embodiment of the present invention does not use a pump other than a coolant pump for working, loss of energy is low. Furthermore, with the coolant device for grinding according to the embodiment of the present invention, a scraping member for separating magnetic chips for the magnetic chip conveyer is not required. Owing to this, it has no wearing portion and expense for maintenance can be reduced.

1. A coolant device for grinding for separating chips from coolant discharged from a grinding machine, the coolant device for grinding comprising:
a coolant tank made of non-magnetic material receiving the coolant discharged from the grinding machine and separating chips,
a magnetic chip conveyer disposed on underside of a bottom plate of the coolant tank, provided with permanent magnets disposed so as to have determined distance between each other and also provided with an endless chain driven rotationally, thus adsorbing magnetic chips precipitated on the bottom plate of the coolant tank with magnetic force of the permanent magnets and separating the magnetic chips from the coolant to discharge them,
a magnetic inline filter for purifying coolant fed from the coolant tank and feeding the purified coolant to the grinding machine, said magnetic inline filter being provided with: a pipe-shaped body as a double pipe consisting of an inner pipe and an outer pipe, which are coaxially disposed, for causing the coolant purified in the coolant tank to flow through space as a gap between the inner pipe and the outer pipe of the double pipe; inner circumferential side magnets disposed on the inner circumferential side of the inner pipe; and outer circumferential side magnets disposed on the outer circumferential side of the outer pipe, and
a pump for feeding the coolant, from which magnetic chips have been separated in the coolant tank, to the magnetic inline filter.

2. The coolant device for grinding according to claim 1,
wherein the coolant tank is composed of plurality of baths contoured with partition walls respectively so that the coolant flows in a direction, and magnetic force of permanent magnets disposed underside of the bottom plate of downstream side bath is stronger than that of permanent magnets disposed underside of the bottom plate of upstream side bath of flow of the coolant.

3. The coolant device for grinding according to claim 2,
wherein the plurality of baths are composed of a first bath, a second bath, a third bath and a fourth bath sequentially in a direction of flow of the coolant, and magnetic strength of the permanent magnets is arranged such that the first bath and the second bath are of a same magnetic strength and the third bath and the fourth bath are of another same magnetic strength stronger than that of the first bath and the second bath.

4. The coolant device for grinding according to claim 1,
wherein the coolant is oily one and the grinding machine is a gear grinding machine grinding gear face with a grinding wheel of CBN.
